(19) United States
(12) Patent Application Publication
(10) Pub. No.: US 2020/0076279 A1
(43) Pub. Date: Mar. 5, 2020

(54) CORRUGATED STATOR

(71) Applicant: GENESIS ROBOTICS AND MOTION TECHNOLOGIES CANADA, Langley (CA)

(72) Inventor: James KLASSEN, Surrey (CA)

(73) Assignee: GENESIS ROBOTICS AND MOTION TECHNOLOGIES CANADA, Langley, BC (CA)

(21) Appl. No.: 16/498,387

(22) PCT Filed: Mar. 28, 2018
(86) PCT No.: PCT/CA2018/050385

§ 371 Date: Sep. 27, 2019

Related U.S. Application Data
(60) Provisional application No. 62/478,022, filed on Mar. 28, 2017.

(51) Int. Cl. H02K 15/02; H02K 1/12; H02K 1/02; H01F 1/153; H01F 1/147

(52) U.S. Cl. CPC H02K 15/02; H02K 1/12; H02K 41/02; H01F 1/15308; H01F 1/14791; H02K 1/02

(57) ABSTRACT

A stator has a backiron and a plurality of posts. The backiron and plurality of posts are collectively at least partially formed from a monolithic soft magnetic material. The plurality of posts define an cross-sectional outline that is larger than the at least portion of the plurality of posts that is formed from the monolithic soft magnetic material.

### RELATED APPLICATIONS

This application claims priority to PCT Application No. PCT/CA2018/050385, filed on Mar. 28, 2018, which further claims priority to U.S. Provisional Application No. 62/478,022, filed on Mar. 28, 2017, which are incorporated herein by reference in their entirety.

### TECHNICAL FIELD

Stator for an electric machine.

### BACKGROUND

Typical electric motor stators are made of laminated sheets of thin steel alloy. This laminated structure has the benefit of reducing eddy currents, but it makes high pole count motors with thin sections problematic with regard to achieving the necessary strength and rigidity to withstand motor forces such as those created by the permanent magnets.

### SUMMARY

In an embodiment, there is disclosed a stator, comprising a backiron and a plurality of posts. The backiron and plurality of posts are collectively at least partially formed from a monolithic soft magnetic material defining continuous flux paths through each of the plurality of posts and the backiron. The plurality of posts define an cross-sectional outline that is larger than the at least portion of the plurality of posts that is formed from the monolithic soft magnetic material.

In an embodiment, there is disclosed a method of manufacturing a stator. A backiron and a plurality of posts are formed from monolithic soft magnetic material using additive manufacturing. The monolithic soft magnetic material is placed within a mold. Dielectric material is added to the monolithic soft magnetic material by filling the mold.

### BRIEF DESCRIPTION OF FIGURES

Embodiments of a rotary actuator will now be described by way of example, with reference to the figures, in which like reference characters denote like elements, and in which:

FIG. 1 an isometric top view of a linear stator showing a representation of eddy currents in stator posts;

FIG. 2 is an isometric end view of the linear stator of FIG. 1 showing a representation of eddy currents in a stator backiron;

FIG. 3 is an isometric side view of the linear stator of FIG. 1 showing a representation of a flux path in the stator;

FIG. 4 is an isometric side view of the linear stator of FIG. 1 with cooling fins;

FIG. 5 is an isometric side view of a linear stator having an open channel between each post and backiron;

FIG. 6 is a cross-section view of the linear stator of FIG. 5;

FIG. 7 is an isometric view of a linear stator with corrugated posts;

FIG. 8 is an isometric view of a linear stator with channels within posts and a backiron;

FIG. 9 is an isometric view of a linear stator with posts and a backiron with internal channels;

FIG. 10 is an isometric view of a single post in a linear stator with a dielectric material integrated with the stator;

FIG. 11 is an isometric view of the linear stator of FIG. 10;

FIG. 12A is a cross-section view along the plane A-A in FIG. 11;

FIG. 12B is a cross-section view along the plane B-B in FIG. 11;

FIG. 12C is a cross-section view along the plane C-C in FIG. 11;

FIG. 12D is a cross-section view along the plane D-D in FIG. 11;

FIG. 13 is an isometric view of a single post of the stator of FIG. 10;

FIG. 14 is an isometric view of a single post of the stator of FIG. 10 with a central connector adjacent to the airgap on the post;

FIG. 15 is an isometric view of a single post of the stator of FIG. 10;

FIG. 16 is an isometric view of a single post of the stator of FIG. 10;

FIG. 17 is an isometric view of a single post of the stator of FIG. 16 with a ceramic coating applied;

FIG. 18 is an isometric view of a single post of the stator of FIG. 17 placed within a mold;

FIG. 19 is an isometric view of a single post of the stator of FIG. 18 with dielectric material placed in the mold;

FIG. 20 is an isometric view of a single post of the stator of FIG. 19 with the mold being removed;

FIG. 21 is an isometric view of a single post of the stator of FIG. 20 after the mold is removed;

FIG. 22 is an isometric view of an axial stator with a rotor;

FIG. 23 is an isometric view of an axial stator with dielectric material integrated within corrugated posts; and

FIG. 24 is an isometric view of a radial stator with dielectric material integrated within corrugated posts.

### DETAILED DESCRIPTION

Various embodiments of stators are disclosed herein, including those of radial, axial or linear design. Various types of coils or windings may be used with the stators to create flux paths in the stator.

In this patent document, the term “boundary” will be used to describe the shortest line enclosing the soft magnetic material in a post or backiron section (analogous to wrapping a cord around the post or backiron) on a plane perpendicular to the flux path between the tip of a post at the airgap to the tip of an adjacent post. In other words, boundary means the shortest perimeter of a stator post or a cross-sectional area of a stator back-iron made of solid material. The term “perimeter” refers to the actual length of the outer surface of the soft magnetic material on the same plane.

In this patent document, a “corrugated” post or backiron means a post or backiron having a boundary that is shorter than its perimeter.

In various embodiments, a stator is disclosed that minimizes the cross-sectional flux path area for the purpose of minimizing the eddy currents produced by the change of magnetic field produced by the electrical current flowing through windings wrapped around its posts. The stators are made by a solid material with posts that may have gaps inside its structure which provide an interrupted or non-continuous perimeter path with functional similarity to a laminate structure with regard to eddy currents reduction by having a corrugated shape or parallel plates with a gap in between them that may be somewhere connected at their ends or in the middle or somewhere along their length; This non-continuous perimeter path structure may be present in the posts, in the back-iron or both posts and back-iron of the said stator. The stator may be made from a soft magnetic solid material through casting, sintering, fusing or additive manufacturing.

The stator may have the said gaps filled with aluminum or any other low density and heat conducting material in the shape of plates, laminates, rods or corrugated shape for the purpose of increasing the structural strength and increasing the thermal conductivity. The aluminium material may be casted, sintered, fused or deposited through additive manufacturing.

Eddy currents are reduced through increasing of the perimeter length through gaps in the said stator posts or back-iron cross-sectional area.

Soft magnetic material refers to a material that can be temporarily magnetised such as but not limited to iron or steel or a cobalt or nickel alloy.

Low reluctance refers to a flux path from one post tip to an adjacent post tip comprised of a preferably uninterrupted soft magnetic material.

The various stators described in this patent document may be made of a monolithic soft magnetic material having a perimeter that is at least 10%, 20%, 30% 40%, 50% longer than the bounding length on a plane that is perpendicular to the flux path.

The various stators described in this patent document may have one or more of the following features. The structure of corrugated posts and backiron can form a structure that creates no eddy current connection around a bounding line for various percentages of the flux path. For example, there may be no eddy current connection around bounding line for 10%, 20%, 30%, 40%, 50%, 60%, 70%, 80% or 90% (or between these values) of flux path from the tip of a post to the tip of an adjacent post.

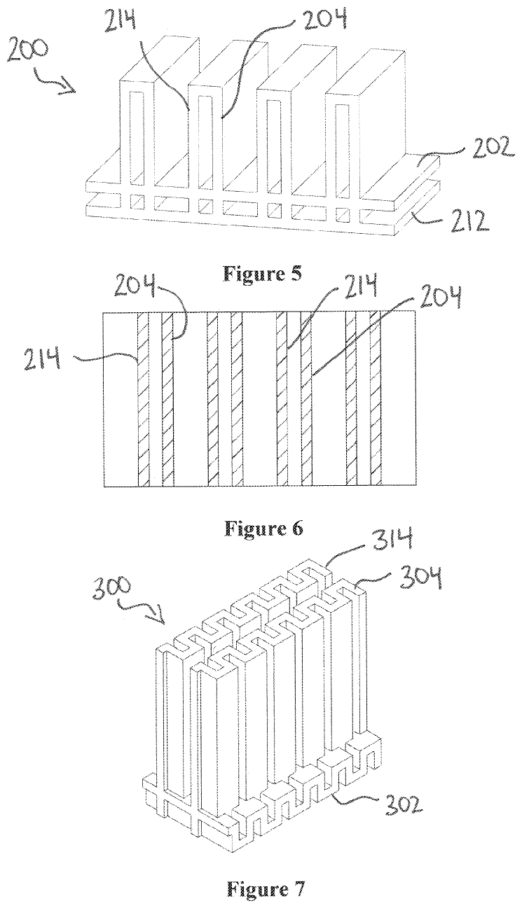

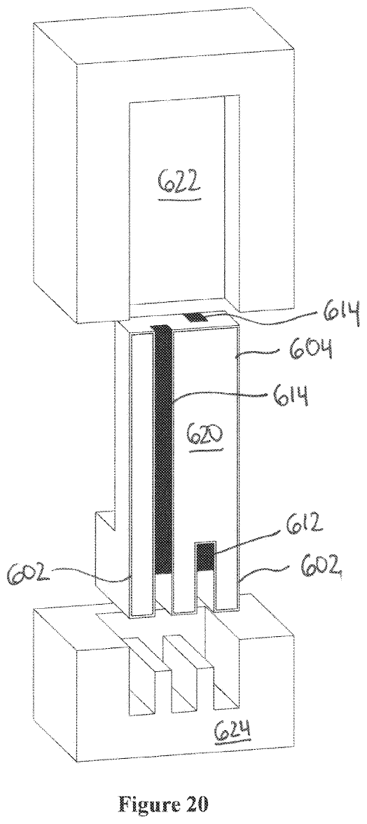

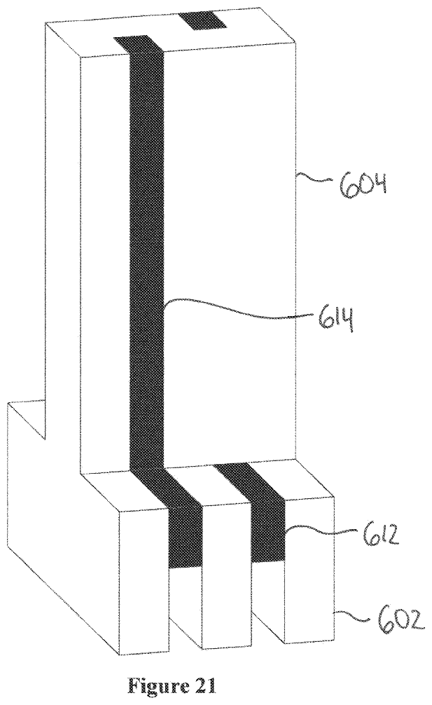

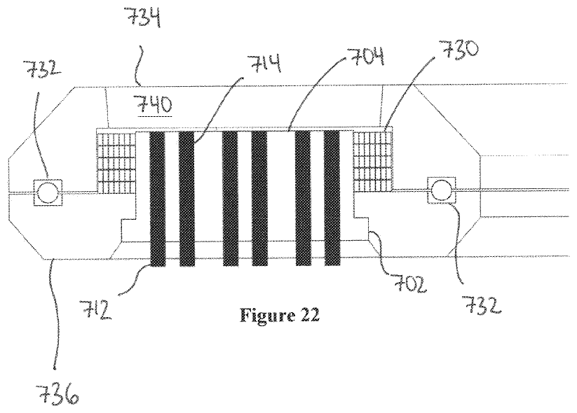

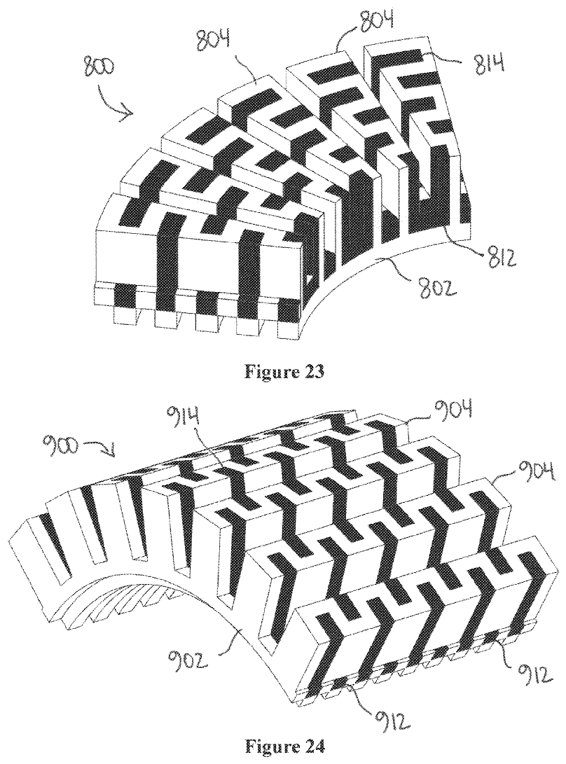

The corrugated stator structure can be applied to a range of motor constructions including radial flux (FIG. 24), axial flux (FIGS. 22 and 23), transverse flux, and linear motors (FIGS. 5 to 21) or other types of electromagnetic machines.

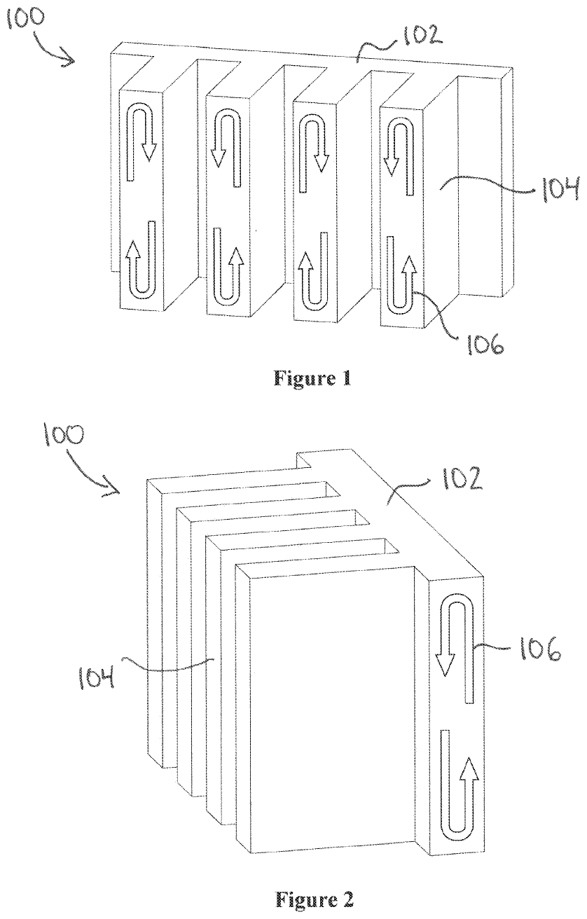

FIGS. 1 and 2 show eddy currents 106 that can form in a solid stator 100. The eddy currents may be formed within a plurality of posts 104 (FIG. 1) or backiron 102 (FIG. 2). Eddy currents may form in the stator due to rotor magnets moving past the stator but also from the switching of the internal coils. Eddy currents can reduce the efficiency of an electric motor or otherwise interfere with the proper functioning of the motor.

FIG. 1 shows the eddy currents 106 that are generated in the posts 104 of a solid stator 100 when the magnetic field generated by the coils changes such as when the stator is commutated (coils not shown in these drawings).

FIG. 2 shows the eddy currents that are generated in the backiron 102 of a solid stator 100 when the magnetic field generated by the coils changes.

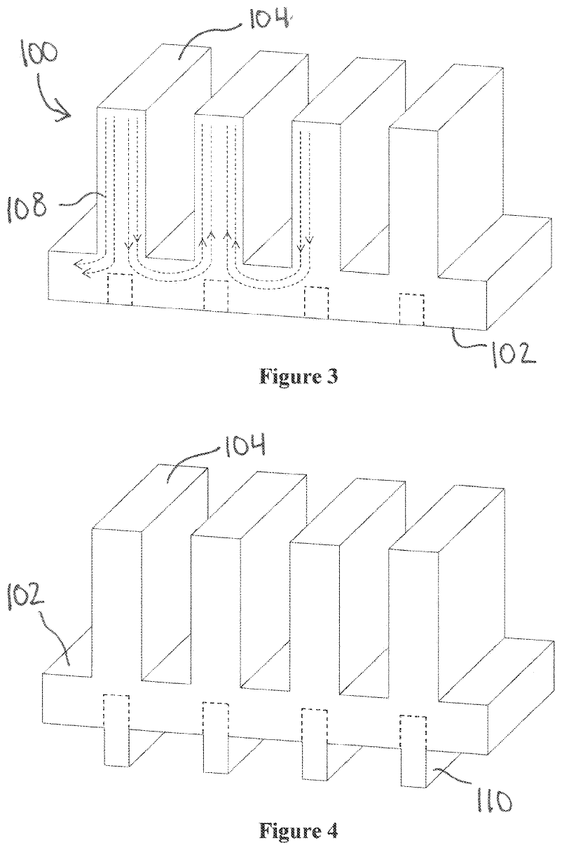

FIG. 3 shows the flux paths in each of the posts 104 which may be caused by coils (not shown). FIG. 3 shows a side view of the solid stator 100 section with the flux lines between posts and a “dead zone” of lower magnetic flux where eddy current generation will be lower than at other areas in the post 104 and backiron 102. This dead zone can therefore be solid along the length of a post to increase the structural rigidity and strength of the stator along the direction of the post. This is useful in applications such as an axial flux motor where the airgap must be maintained against the attraction created between the stator and rotor by the permanent magnets.

FIG. 4 shows the stator 100 with cooling fins 110.

FIGS. 5 and 6 show a stator 200 having a corrugated backiron 202 with upper and lower pieces 202, 212 and forming an open channel between them and a plurality of corrugated posts with inner and outer pieces 204 and 214 each forming an open channel between them. The backiron 202 and plurality of posts are collectively at least partially formed from a monolithic soft magnetic material. The plurality of posts define an cross-sectional outline that is larger than the at least portion of the plurality of posts that is formed from the monolithic soft magnetic material. The monolithic soft magnetic material in the backiron 202 and posts 204, 214 define continuous flux paths through each of the plurality of posts and the backiron

As shown in FIGS. 5 and 6, the channels between the upper and lower pieces 202 and 212 and the inner and outer pieces 204 and 214 form one or more blind slots in the soft magnetic material that are aligned with the flux path and perpendicular to the eddy current path.

FIGS. 7 to 21 show different configuration of corrugated linear stators with different variations of shape of monolithic soft magnetic material and different shapes and sizes of channels within the posts and backiron. The benefits of the embodiments in FIGS. 7 to 21 are similar to those described in FIGS. 5 and 6 and the following description focuses on where the structure of the various embodiments is different.

FIG. 7 shows a corrugated stator 300 having a different structure of corrugated backiron 302 and a first and second corrugated posts 304 and 314. The posts 304 and 314 form a zigzag shape that defines channels that are formed in an alternating arrangement on either side of the posts. The channels are parallel with the flux path within the stator and extend from the backiron to the end of the posts adjacent to the airgap.

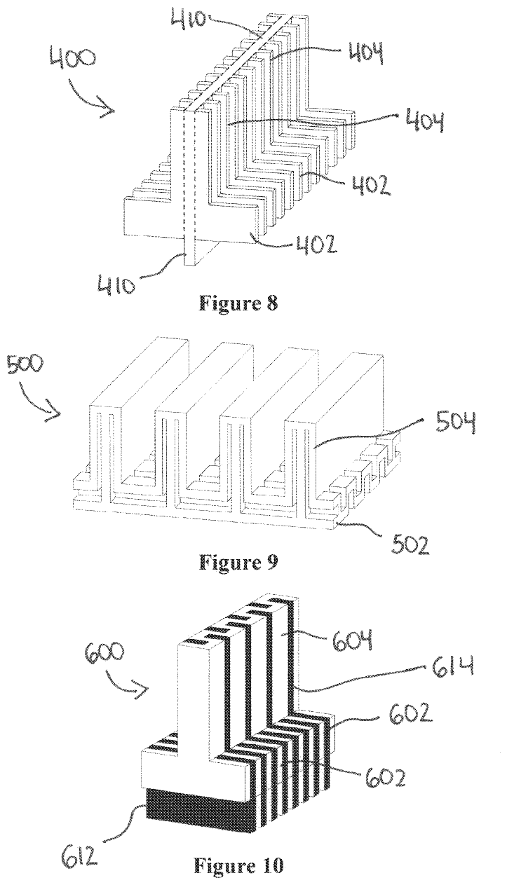

FIG. 8 shows a single post of a corrugated stator 400 having a central connector 410 and the post formed from a plurality of interconnected sheets 404 and a backiron formed from a plurality of interconnected sheets 402. Channels are formed between the plurality of interconnected sheets 402 and 404.

In the various embodiments disclosed in this patent document, the posts and backiron may be formed from combination of ferrous steel and low electrical conductivity metal such as titanium. A material such as titanium may be selected for strength. A ferrous material may be selected for its magnetic properties.

FIG. 9 shows a corrugated stator 500 having a plurality of posts 504 having internal channels that are parallel to the flux path of the stator. A backiron 502 has an alternating pattern with blind holes on the inner and outer ends of the backiron 502.

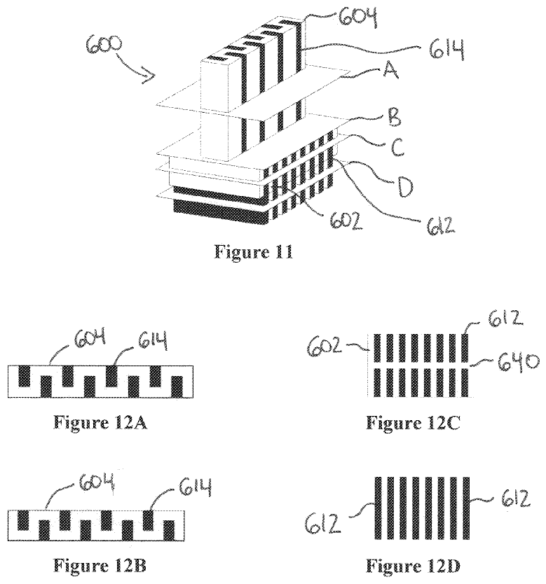

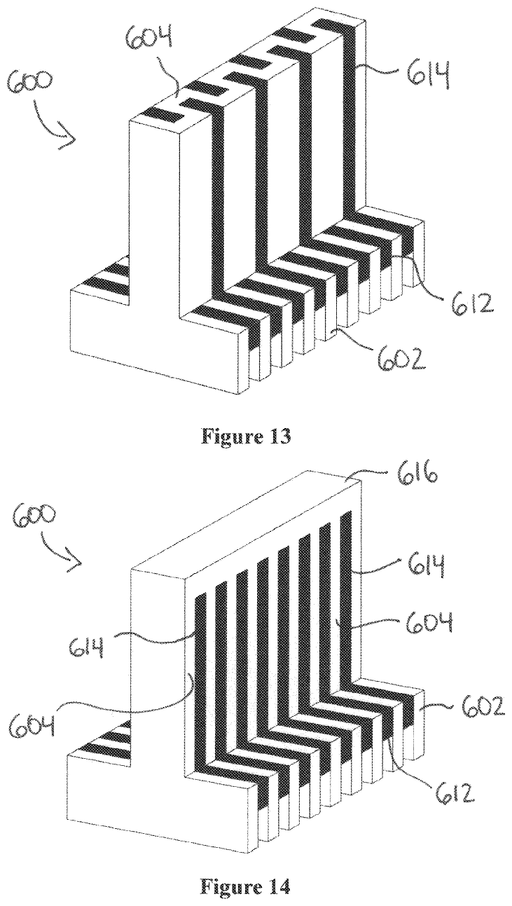

FIGS. 10 to 21 show a single post 604 of a corrugated stator 600. The post 604 define an alternating pattern of channels parallel to the flux path of the stator and extending along the post from the backiron to the airgap. The channels in the post are filled with a dielectric material 614. As shown in FIGS. 12A to 12D, there are a number of discrete channels. A backiron is formed from a plurality of parallel sheets 602 that have channels extending along the length of each sheet 602. The channels in the backiron are filled with a dielectric material 612. As shown in FIG. 12C, a central piece 640 of the backiron extends between sheets 602 to allow for the flux path to extend between each of the sheets 602. As shown, for example, in FIGS. 13 and 14, the sheets 602 that together form part of the backiron may extend below the backiron in a direction away from the airgap to form cooling fins.

In some embodiments, such as shown in FIG. 14, the posts may include a central portion of a solid post cap 616 at the airgap that creates an eddy current path at the airgap. The generation of such eddy currents at the airgap may be tolerated because the benefit of increased strength may be worth the disadvantages for some applications.

Bridging members such as the solid post cap 616 (FIG. 14) or upper and lower pieces 202, and 212 (FIG. 4) are situated in areas where they do not fully connect the boundary/bounding line of a post or backiron section on a plane perpendicular to the flux path. The bridge members may connect all or part of the boundary shape on a plane perpendicular to the flux path in the backiron at the base of a post such as shown in FIGS. 3 and 4. This has the advantage of increasing structural strength and rigidity (for example in the radial direction in an axial motor) where the flux density is relatively low as shown in FIG. 3. The bridging members may also or instead appear only at the airgap where a small % of eddy current is tolerated to produce a lower reluctance flux path at the air gap as shown in FIG. 14.

The creation of an interrupted eddy current path may be created by means of thin sections of material cast or fused or formed or otherwise formed together as part of the manufacturing process whereby thin sections are joined together by bridging sections of the same monolithic material as disclosed in FIGS. 5 to 14.

The slots, gaps or channels in the various embodiments described may be filled with a material such as aluminum with a higher heat conductivity. The higher heat conductivity material may be uninterrupted from a post slot to the back surface of the backiron. The higher heat conductivity material may protrude past the back surface of the back iron to create cooling fins.

The embodiments described herein may be produced by additive manufacturing methods. The various embodiments disclosed here take advantage of the fine detail that is possible with manufacturing processes such as, but not limited to additive manufacturing of metal components such as but not limited to laser sintering or other 3D printing processes. The structure combines a flux path from post to post that has a majority of its volume slotted in such a way as to reduce or prevent a continuous electrical connection from forming around the boundary of a post or backiron between posts.

This structure for an electromagnetic stator made of a solid (unified, monolithic) soft magnetic material may provide a low reluctance flux path from post to post with reduced eddy currents due to the thin sections of materials between the slots that interrupt the flux path bounding line, while at the same time providing adequate mechanical strength and stiffness (for example in the axial direction to maintain the air gap in an axial flux motor).

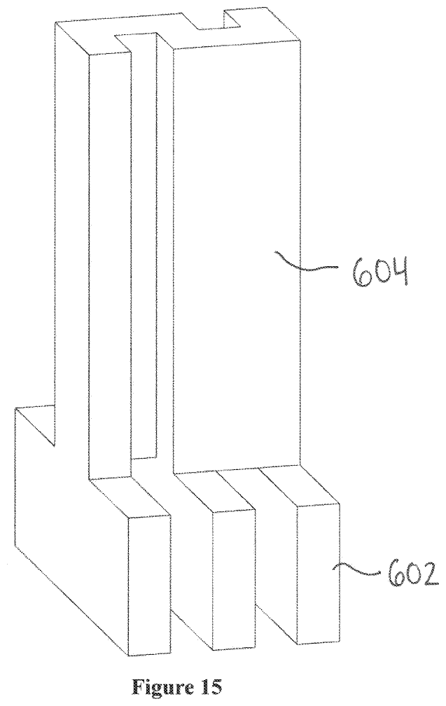

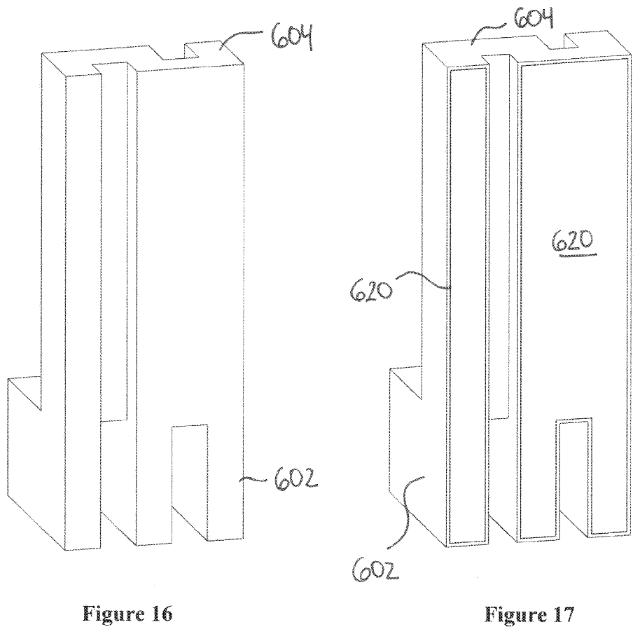

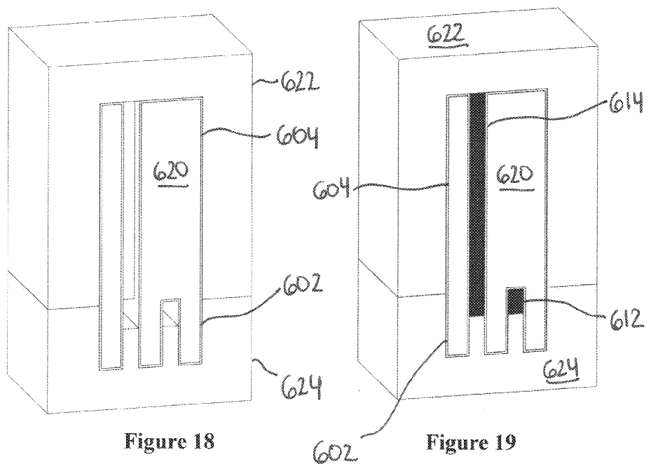

FIGS. 15 to 21 illustrate a method of constructing the various corrugated stators as described in this patent document. As shown in FIGS. 15 and 16, the stator 600 can be formed by three dimensionally printing the corrugated steel backiron 602 and steel posts 604. As shown in FIG. 17, the stator 600 may be coated with ceramic 620. As shown in FIG. 18, the stator 600 may then be placed in a mold, for example, having two halves 622, 624 and filled with aluminum inserts 612, 614 within the mold as shown in FIG. 19.

FIG. 22 shows an example of a stator 700 for an axial machine having a housing 736 being placed within an electric motor. The stator 700 is connected to a rotor 734 by means of inner and outer bearings 732. The rotor includes permanent magnets 740. Conductors 730 are shown surrounding a post 704. Aluminum inserts 712 and 714 are molded into the stator. The lower end of the aluminum inserts 712 extend below the backiron to form cooling fins. The posts and backiron may be at least partially formed by a monolithic soft magnetic stator material.

FIG. 23 shows an embodiment of a stator 800 for an axial machine. A plurality of posts 804 and a backiron 802 are formed together with a filling dielectric material 812 and 814 in a similar manner to the linear stators described in FIGS. 5 to 21.

FIG. 24 shows an embodiment an embodiment of a stator 900 for a radial machine. A plurality of posts 904 and a backiron 902 are formed together with a filling dielectric material 912 and 914 in a similar manner to the linear stators described in FIGS. 5 to 21.

As described in this patent document, any soft magnetic material can be used including ferrous iron or steels and/or nickel and/or cobalt and/or amorphous metals.

Additional elements may also be added to the soft magnetic material such as silicon may be used to reduce electrical conductivity.

In some embodiments, the gaps between thin sections of soft magnetic material are thinner than the soft magnetic material on both sides of a gap. Gaps, slots or channels formed within the backiron or posts may be filled with high dielectric material such as shown in FIGS. 10 to 14. The high dielectric material may be a ceramic.

Additionally or alternatively, ceramic coating, for example ceramic 620 in FIG. 17, on the steel part may be used to prevent electrical connection with aluminum or other higher heat conductivity material when aluminum is infused into the gaps in a mold.

Although the foregoing description has been made with respect to preferred embodiments of the present invention it will be understood by those skilled in the art that many variations and alterations are possible. Some of these variations have been discussed above and others will be apparent to those skilled in the art.

In the claims, the word “comprising” is used in its inclusive sense and does not exclude the possibility of other elements being present. The indefinite article “a/an” before a claim feature does not exclude more than one of the feature being present unless it is clear from the context that only a single element is intended.

1. A stator, comprising:
a backiron;
a plurality of posts;
the backiron and plurality of posts are collectively at least partially formed from a monolithic soft magnetic material defining continuous flux paths through each of the plurality of posts and the backiron; and
in which the plurality of posts define an cross-sectional outline that is larger than the at least portion of the plurality of posts that is formed from the monolithic soft magnetic material.

2. The stator of claim 1 in which the portion of the plurality of posts that is formed from the monolithic soft magnetic plurality of posts form a corrugated structure.

3. The stator of claim 1 in which the backiron is corrugated.

4. The stator of claim 1 in which the backiron further comprises one or more channels.

5. The stator of claim 4 in which the one or more channels extend along the flux path of the stator.

6. The stator of claim 4 in which the one or more channels are filled with a dielectric material.

7. The stator of claim 1 in which each of the plurality of posts further comprise one or more channels.

8. The stator of claim 7 in which each of the one or more channels extend in parallel to the flux path of each of the plurality of posts.

9. The stator of claim 7 in which the one or more channels are filled with a dielectric material.

10. The stator of claim 1 in which the plurality of posts are coated with a ceramic material.

11. The stator of claim 1 in which the soft magnetic material is formed from one or more of the following materials: ferrous iron, steels, nickel, cobalt and amorphous metals.

12. The stator of claim 11 in which the soft magnetic material further comprises a silicon additive.

13. The stator of claim 6 in which the dielectric material comprises aluminum or ceramic.

14. The stator of claim 1 in which the monolithic soft magnetic material further comprising one or more bridging members connecting between the plurality of posts and backiron.

15. A method of manufacturing a stator, comprising:
forming a backiron and a plurality of posts from monolithic soft magnetic material using additive manufacturing;
placing the monolithic soft magnetic material within a mold; and
adding dielectric material to the monolithic soft magnetic material by filling the mold.
